(19) United States
(12) Patent Application Publication
(10) Pub. No.: US 2007/0058043 A1
(43) Pub. Date: Mar. 15, 2007

(54) Real-time IPTV channel health monitoring

(75) Inventor: Vivek Thukral, Palo Alto, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/215,641

(22) Filed: Aug. 30, 2005

(51) Int. Cl. H04N 17/00

(52) U.S. Cl. 348/180

(57) ABSTRACT

Systems and methods for monitoring health of Internet Protocol television channels in real-time are described. In one implementation, a monitoring system discovers the distribution paths for multiple channels and proactively pings for component health and audio-visual (AV) quality at different segments of the paths. Health of components and AV quality are displayed in a collapsible tree form of user interface. A channel problem is marked on the tree in a manner that indicates how to expand the tree to trace the problem.

### RELATED APPLICATION

The present application is related to U.S. patent application Ser. No. ______ (Atty Docket # MS1-2689US) to Vivek Thukral, entitled “Real-time Audio-Visual Monitoring In A Network,” filed on Aug. 30, 2005 and incorporated herein by reference in its entirety.

### BACKGROUND

A television network that uses the Internet for distribution, that is, Internet Protocol television (IPTV), requires the same high levels of quality and availability that are demanded of an Internet service provider and in addition the same high levels of quality and availability that are demanded of a conventional analog or digital television network. The distribution system for simultaneously streaming numerous channels of streaming IP video packets to thousands of subscribers—i.e., multicasting—is complex and the tolerances for transmission errors and downtime are vanishingly small. That is, if downtime causes subscribers to miss a few important seconds of a television program, the experience of watching the television program can be ruined. If the problem persists, subscribers are likely to phone the television network provider with alerts or complaints. In many circumstances, such a network failure also breaches the network's contract to provide services to the subscriber at certain levels of quality and availability.

Conventional tools that monitor the data-delivery health of an IP television network are limited to a component-based approach, e.g., they monitor only the server nodes on various tiers of the network. Such conventional approaches adopt a philosophy that if every component in an appliance or a system is working properly, then the entire system is likely problem-free. Likewise, if a problem arises, as when a subscriber or group of subscribers contact the network's technical support department, then a system-wide examination of each component tries to find a faulty component responsible for the problem.

These conventional component-based techniques just described for monitoring television network health have several deficiencies. First, a problem may occur on the network that is not caused by a monitored component. Second, even if the problem is caused by a monitored component, a typical IP television network is vast, and it may require significant time to conventionally monitor all the component nodes. The conventional tools do not indicate where to start looking for the faulty component, so the troubleshooter must rely on process of elimination and luck, and significant time are resources are wasted. With a merely component-based search approach, these conventional tools are not able to systematically examine the network in any logical manner to find problems.

Another difficulty is that a conventionally monitored component may not know how to report the problem it is having. Each component may be outfitted to report certain types of data-delivery problems that are common to the Internet, but not those types of problems that are unique to television viewing quality. This last point is the most important deficiency of conventional tools for monitoring the channel health of IP television networks. The conventional tools are not able to monitor or understand problems that occur in the television video frames that are being carried by IP packets, that is, they are not able to abstract or interpret television audio-visual (AV) quality problems from the IP data packets.

### SUMMARY

Systems and methods for monitoring health of Internet Protocol television channels in real-time are described. In one implementation, a monitoring system discovers the distribution paths for multiple channels and proactively pings for component health and audio-visual (AV) quality at different segments of the paths. Health of components and AV quality are displayed in a collapsible tree form of user interface. A channel problem is marked on the tree in a manner that indicates how to expand the tree to trace the problem.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram of an exemplary channel health-monitoring engine in relation to an Internet Protocol television network.

FIG. 2 is a diagram of an exemplary channel health-monitoring engine in relation to a hierarchically arranged Internet Protocol television network.

FIG. 3 is a block diagram of an exemplary channel health-monitoring engine for Internet Protocol television.

FIG. 4 is a diagram of an exemplary user interface.

FIG. 5 is a second diagram of an exemplary user interface.

FIG. 6 is a third diagram of an exemplary user interface.

FIG. 7 is a flow diagram of an exemplary method of real-time channel health-monitoring for Internet Protocol television.

### DETAILED DESCRIPTION

Overview

Described herein are methods and systems for real-time IPTV channel health-monitoring. In one implementation, an exemplary channel health-monitoring system proactively monitors the health of IPTV network components, and at the same time also monitors the audio-visual (AV) quality at nodes and links between nodes of the network's channel distribution paths. The exemplary monitoring system provides immediate access to the entire IPTV network, proactively giving a frequently updated status report of component health and AV quality of the entire network in a single user interface (UI).

“Proactively” means that instead of waiting for a human subscriber to report a problem, or even instead of waiting for a component to report a problem, the exemplary monitoring system gathers statuses before problems arise, at every tier of the IPTV network, and monitors the AV quality of the packet stream flowing through the links of the network, from one node to another (a link), querying the AV quality on each link and making sure that the channel is accessible and of good quality everywhere on the channel path before a problem is actually reported.

“Health,” as used herein has a dual sense. Health first refers to the data-delivery capability and availability of the IP network that underlies channel delivery—that is, the hardware and software components of the network and their related parameters, such as usage, availability, packet loss, quality of service, error count, etc. Secondly, health refers on a higher level to the quality of the video frames of television content being provided through the medium of IP data packets. An apparently severe problem in the IP network realm may only affect one frame of video and thus be a negligible problem on the AV quality plane, and vice versa.

The health of the network components—as well as the quality of the video frames represented by the IP data packets at the links and components—are proactively monitored at frequent intervals, e.g., by pinging them. An exemplary monitoring system (also referred to herein as a monitoring “engine,” “service,” or “tool”) visually displays detected problems in the exemplary UI introduced above that can collapse and expand a tree representation of the entire network into those segments that are visually relevant for tracing a problem within a huge network. This ability to change level of view allows the exemplary UI to begin at an overall view and drill down to a specific component, without the troubleshooter getting lost in the entire network.

In one implementation, the exemplary UI displays in real-time the relative degree of component health by the character of the icon or symbol used to display the node in the UI. Likewise, the UI displays the relative AV quality of the stream flowing in the links between nodes by the character of the line between nodes. For example, the lines representing links between nodes may be color coded to represent the AV quality.

Significantly, in one implementation, the exemplary channel health-monitoring system not only provides textual data about the AV quality of various segments of the network but also provides the capability of real-time display of AV quality via simultaneously rendered television images and/or sound at multiple vantage points selected anywhere on the network, as described in companion U.S. patent application Ser. No. ______ to Vivek Thukral, entitled “Real-time Audio-Visual Monitoring In A Network,” filed on Aug. 30, 2005 (the “Thukral reference”). This allows side-by-side visual (and audio) comparison of the AV frames being carried by IP packets rendered at two or more selectable points along the distribution path of a televised channel. Thus, when a subscribing customer calls the television service provider stating, “I don't have video,” the channel health-monitoring system described herein gives immediate access to an entire channel path from backend to set-top box. Then the system allows an operator to view what the client is seeing or not seeing at that very moment and to make comparisons based on data and visualizations of the video frames from anywhere on the entire channel path. Thus, the operator can perform diagnostics of both components and AV quality anywhere on the channel path, to quickly determine the location and cause of the problem.

The elements just described are separately powerful tools. When combined in the exemplary monitoring system, they have a synergistic effect that allows the human operator to find and solve IPTV problems with extraordinary speed as compared with conventional techniques.

Exemplary System

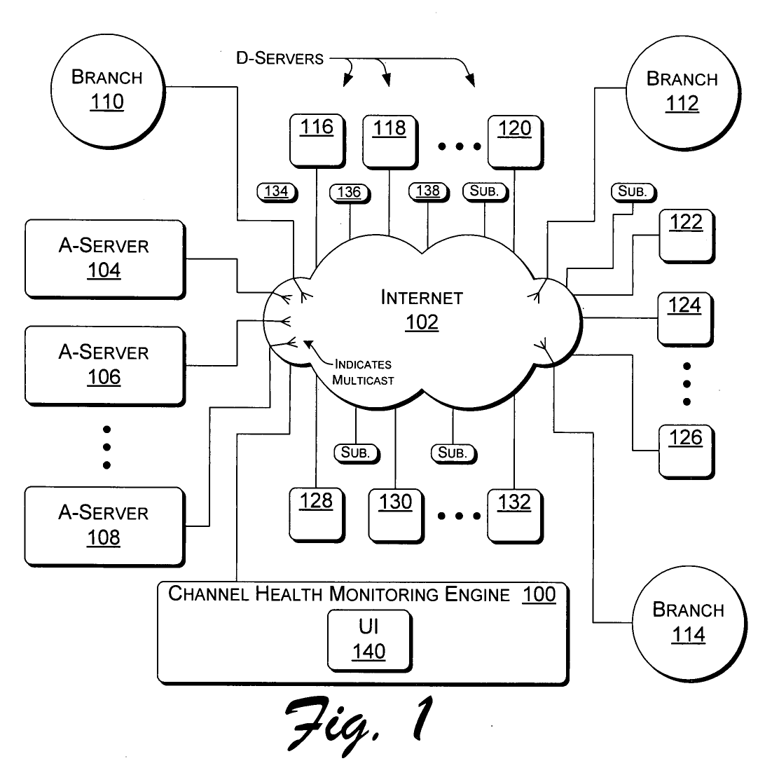

FIG. 1 shows the exemplary channel health-monitoring engine 100 as it relates to an IPTV system and to the Internet 102. The various components of the IPTV system can dwell in different geographical locations but are each connected to the Internet 102. Therefore, the distribution path of a given televised channel is not always obvious from a schematic such as illustrated in FIG. 1. The backend of the IPTV system typically consists of source servers, such as A-Servers 104, 106, 108, where one A-Server node originates or “hosts” a single channel of a channel lineup. That is, an A-Server (e.g., 104) originates the IP multicast of video frame packets for its respective channel.

Each A-Server 104 multicasts to branch nodes, such as branch servers 110, 112, and 114. The branch servers (e.g., 110) serve as connecting nodes between one or more of the A-Servers 104 and a main division of the IPTV network, such as a main divisional branch 110 that supplies multiple television channels to an entire city. An individual branch 110 multicasts one or more channels to a cluster of end server nodes, known as D-Servers (116, 118, . . . 120) on the outer “edge” of the IPTV network. There may be many branches (110, 112, . . . 114) each serving a cluster of D-Servers (e.g., 116), such as branch 112 serving the cluster of D-Servers 122, 124, . . . 126 and branch 114 serving the cluster of D-Servers 128, 130, . . . 132. Finally, individual subscribers (e.g., 134, 136 . . . 138) are served an IP television channel via one of the individual D-Servers 116.

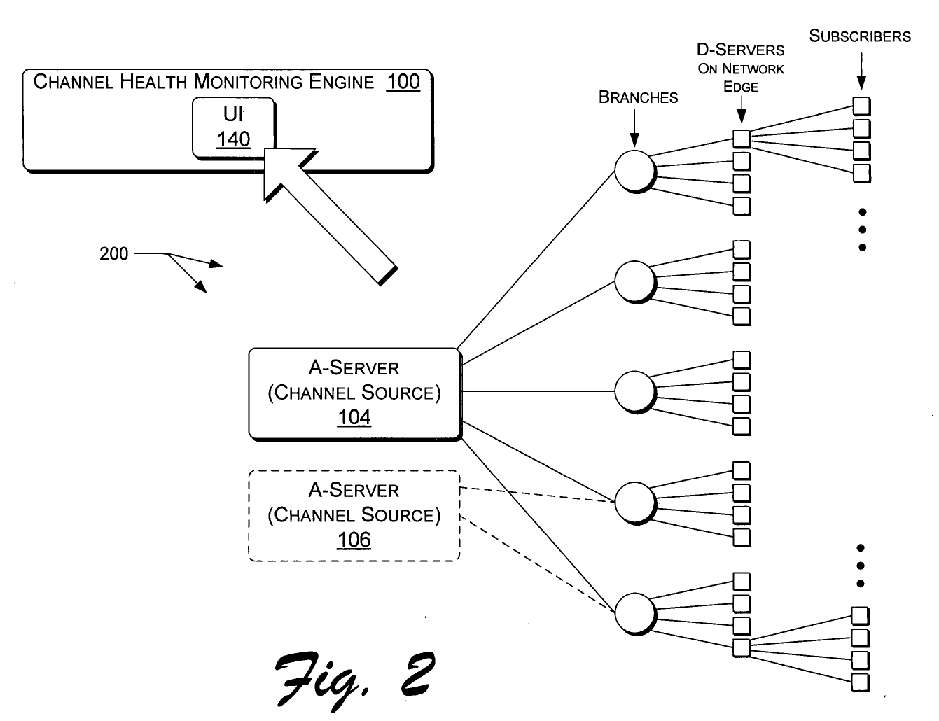

FIG. 2 shows the IPTV network and the channel health-monitoring engine 100 of FIG. 1, but this time the IPTV network is arranged according to interrelationships between nodes in a hierarchical tree structure 200 instead of in relation to the Internet 102.

The various stages of the hierarchical tree structure 200 constitute the tiers of the IPTV network—such as an A-Server tier, a branches tier, a D-Server tier, and a subscribers tier. Typically the nodes constituting the tiers are also the endpoints of the links between the tiers, and it is these endpoints and links that are most typically represented in the hierarchical tree structure 200, to be displayed in collapsible and manipulable form in the exemplary UI 140. Generally, in the IPTV network itself, each link to be represented in the UI 140 actually consists in part of the Internet 102, as previously shown in FIG. 1, but the Internet nature of a link does not need to be shown when the link is represented as a line in the exemplary UI 140.

Exemplary Engine

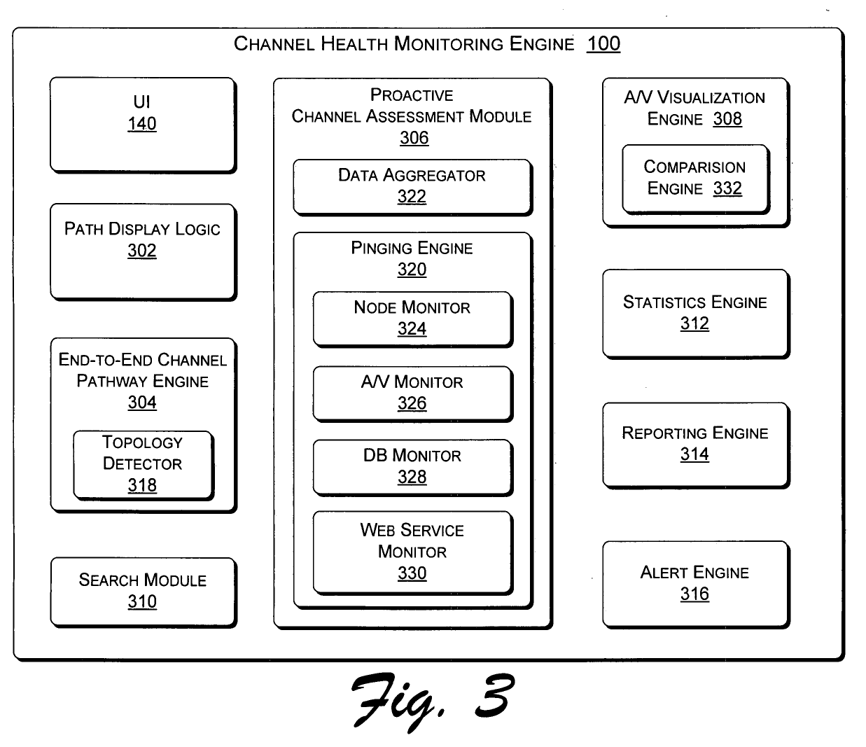

FIG. 3 shows the exemplary channel health-monitoring engine 100 of FIGS. 1 and 2 in greater detail. The illustrated configuration of the exemplary monitoring engine 100 is meant to provide one example arrangement for the sake of overview. Many other arrangements of the illustrated components, or similar components, are possible. Such a monitoring engine 100 can be executed in hardware, software, or combinations of hardware, software, firmware, etc.

The monitoring engine 100 includes the UI 140, path display logic 302, an end-to-end channel pathway engine 304, a proactive channel assessment engine 306, and an AV visualization engine 308. The monitoring engine 100 also includes a search module 310, a statistics engine 312, a reporting engine 314, and an alert engine 316. The end-to-end channel pathway engine 304 further includes a topology detector 318. The proactive channel assessment engine 306 further includes a pinging engine 320 and a data aggregator 322. The pinging engine 320 further includes a node monitor 324, an AV monitor 326, a database (DB) monitor 328, and a web service monitor 330. The AV visualization engine 308 further includes a comparison engine 332 for making side-by-side comparisons of rendered AV content selected from different points along a channel distribution path.

The exemplary engine 100 uses the pinging engine 320 to proactively assess a variety of entities associated with each channel. The delivery of each channel over IP uses multiple machines, encoders, databases, and services spread over a multi-tier architecture to deliver the channel from backend all the way to the subscriber. The exemplary engine 100 monitors individual components, such as servers, to determine status and problems they are reporting, but collecting and correlating this type of error reporting from components along the channel path is in itself of only limited use in determining why a particular subscriber is having a problem and where the problem is located.

In the exemplary monitoring engine 100, the end-to-end channel pathway engine 304 has a topology detector 318 that discovers the distribution path of each televised channel from backend source to subscriber, and displays in the UI 140 a highly manipulable and logically organized representation of the entire IPTV network (or a relevant segment). The topology detector 318 may use standard IP techniques to discover a channel distribution path. With IP/TCP, for example, it is relatively easy to discover a succession of nodes that describe the route of an IP packet and build a node topology, or in this case, the channel path, all the way to the subscriber without actually communicating with the subscriber's set-top box.

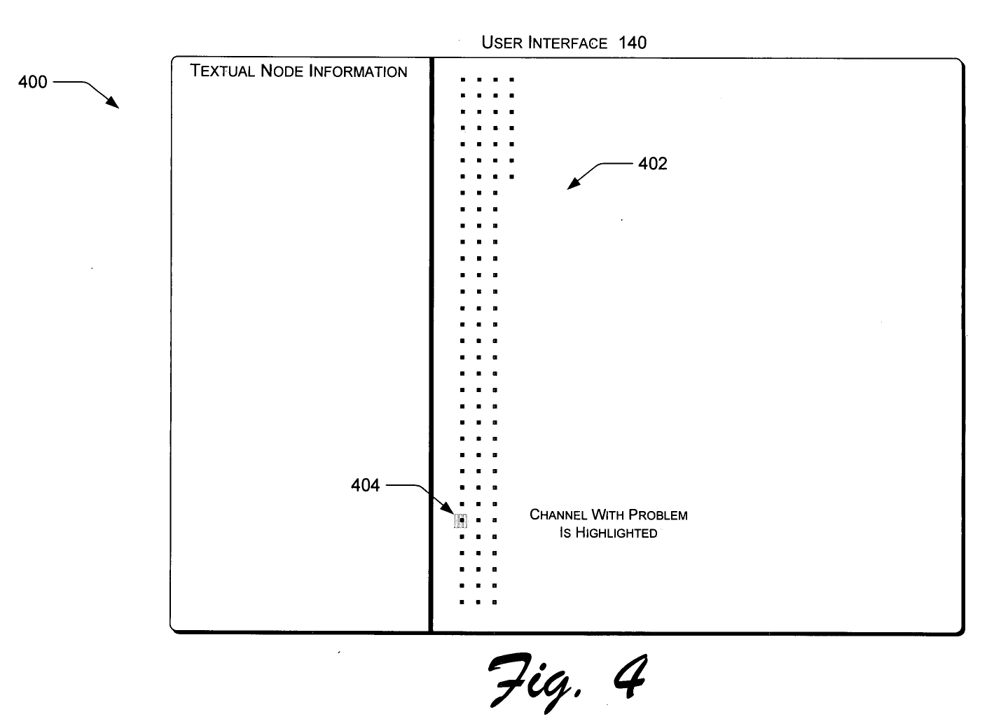

Path display logic 302 controls the collapsing and expanding of the displayed tree representation 200 based on a detected problem or on the operator's input in tracing the problem, for example by clicking a mouse. In one implementation, when a problem is detected, the path display logic 302 may display, as shown in FIG. 4, a top-level representation 400 of the IPTV network that just shows the top-tier backend A-Servers 402. Whichever channel path has the problem is indicated by highlighting the A-Server 404 for that channel.

Referring again to FIG. 3, the exemplary monitoring engine 100 typically performs its dual monitoring of AV quality and component health at the data inputs and data outputs of each node or other endpoint of each tier in the IPTV network.

The proactive channel assessment module 306 takes a proactive approach to mapping the current health of an IPTV network by pinging each component for both AV quality and component data-delivery health at regular intervals and sending a complete health snapshot of the network to the data aggregator 322. The pinging engine 320 requests health information from each monitored component or endpoint in the entire network at frequent intervals, for example, every twenty seconds, or once per minute, etc. Thus, the node monitor 324, the database monitor 328, and the web service monitor 330 each ping their respective components or entities in a concerted manner controlled by the pinging engine 320.

The AV monitor 326 may ping the same components as the node monitor 324, but for a different purpose. The AV monitor 326 seeks information about AV frames and their quality, not necessarily about packet delivery as such and component health as such. For example, encoding and decoding problems give discontinuity problems in frames, which affect the video quality. When a data packet is lost on the network, then the next frame may be marked as discontinuous (i.e., “one frame was lost”). The effect of many discontinuous frames is obvious to a viewer and then AV quality is compromised. The AV monitor 326 can look into the channel stream and proactively monitor the AV quality of the stream itself in each link of the network (between nodes). The AV monitor 326 may not communicate directly with components, but instead may tune into the multicast and measure AV quality at the IP addresses.

In one implementation, the component health information gathered by the node monitor 324 is represented by the character of the icon or symbol used to display each node in the UI 140, while the AV quality between the nodes is represented by the character of the line between nodes. Hence, in one implementation excellent AV quality between nodes is displayed as a green or solid line, while poor AV quality between nodes is displayed as a red or dashed line.

The AV monitor 326 can determine AV quality proactively. As the node monitor 324 can detect and/or collect component statuses, error reports, packet loss counts, etc., the exemplary monitoring engine 100 can use the AV monitor 326 to determine the impact of various health parameters on AV quality. For example, the AV monitor 326 can derive an assessment of AV quality for each link of the network from proactively measured packet and frame transport attributes of each link. Such transport attributes can include frame rate, changes in frame rate, discontinuous frames (i.e., dropped frames), impact of packet loss on video frames, etc.

Sometimes poor AV quality is caused by components of the IPTV system or the network that introduce delay into the multicast, thereby causing jitter in audio and/or video parts of the multicast. Accordingly, in one implementation, the AV monitor 326 proactively detects AV jitter by measuring video frame rate and audio sample rates. For example, the AV monitor 316 may detect this AV jitter by measuring video frame rate and/or audio sample rates for the time interval constituting each ping period (i.e., monitoring interval).

Poor AV quality can also be caused by loss of AV input in a link of the IPTV network, particularly at the source, where encoders typically multicast black or color bars on loss of input. This condition is difficult for AV components to detect or report since the encoder's output—the black or color bar multicast output—is a valid multicast transport input for the network's downstream components. So, the individual AV components of the IPTV network cannot detect that anything is wrong, even though there is no signal carrying AV programming content. Accordingly, in one implementation, the AV monitor 326 can detect this condition of no-signal-feed/no-input to the encoder by measuring motion between first and last video frames in the monitor (“ping”) interval.

The above conditions of poor AV quality in a link of the network can be detected by the human intervention of watching rendered video and/or audio of the channels, for example, as rendered by the AV visualization engine 308. But, it is not practical to adopt human monitoring of rendered video around the clock, so the AV monitor 326 automates a proactive version of these AV quality detecting tasks with each ping interval.

Within each ping, the pinging engine 320 monitors health and quality information for all channels being processed by each component, link, or endpoint, without unduly burdening the components being pinged. In its capacity as a pinging tool, the exemplary monitoring engine 100 assumes that sometimes components are not “smart” enough to detect their own problems, or sometimes just do not report problems. The node monitor 324, therefore, tunes to the channels proactively, finds response times, for example, and evaluates whether there is a problem with a channel, while the AV monitor 326, for example, evaluates the level of AV quality going into and coming out of each link or component.

If there is a problem with component health or AV quality, the path display logic 302 maps at least part of the network to show the location of the problem, if known. Since the exact location or cause of a problem may not be known, the operator can use the UI 140 to trace the problem. Even if there is no problem, the operator can peruse the network from different levels of view, using the UI 140. For each link and component of the network that is being displayed, the relevant health or non-health is mapped for display to each displayed link or component.

The exemplary monitoring engine 100 may also incorporate an AV visualization engine 308, such as that described in the Thukral reference cited above. The AV visualization engine 308 allows the operator to join a multicast of a channel anywhere along the channel path as displayed in the UI 140. The operator can then visualize the quality of actual televised images in real-time as they are being transmitted over IP. The AV visualization engine 308 includes a comparison engine 332, that allows side-by-side comparison of multiple simultaneous renderings of the same televised video content, but drawn from different points along the channel path. This allows the operator to quickly troubleshoot AV quality across tiers of the channel path, or between input and output of a single component or node. That is, the side-by-side visual comparison of multiple AV images at any selected points on the distribution path of a channel occurs in the exemplary UI 140, for example, as two windows of rendered video overlaying the UI 140.

The information collected over various pings by the proactive channel assessment engine 306 is compiled at the data aggregator 322 and may immediately update the UI 140 via the path display logic 302. The information at the data aggregator 322 can also be sent to the statistics engine 312 and the reporting engine 314. The statistics engine 312 can incorporate algorithms to interpret data and draw conclusions—e.g., whether a problem exists—and may compile statistics, such as keeping track of uptime (how long since the last channel downtime), downtime, availability, usage, load, load balance, average quality, number of errors, etc. The monitoring engine 100 may monitor thresholds via information from the statistics engine 312, for example, whether the number of dropped packets or dropped video frames is above an acceptable level. The statistics engine 312 can also reveal the quality of services provided for purposes of maintaining a level of service specified in the client's subscription contract.

The various assessment parameters, such as usage, availability, uptime, video quality, etc., may be made routinely available in the UI 140 via the reporting engine 314. The reporting engine 314 may use information from the data aggregator 322 to gauge the severity of a problem: for example, perhaps two-hundred subscribers are actually being impacted by a given problem. The reporting engine 314 can offer useful information on how and when to take down or restart a server.

The reporting engine 314 may also report problems or exceeded thresholds to the UI 140 and/or to the alert engine 316. The reporting engine 314 can indicate a favorable time of day for repurposing an individual server, that is can indicate to an operator how many subscribers are using the particular server, and can tell the load factor on each server in the channel path at a given moment. This allows the operator to decide whether to repurpose the server based on exact information about when and how each node is being used. Thus, the exemplary monitoring engine 100 allows the operator to make decisions based on how many subscribers are tuned to a channel, and if the channel goes down, how much latency is involved in bring it back up, etc.

The alert engine 316 may use conventional communication methods to send an alert to an operator. The alert is sent to the UI 140, but can also be disseminated via telephone, email, instant messaging, etc.

The search module 310 allows the operator to find particular information, such as the channel path, with respect to a particular subscriber, and to inform the path display logic 302 to display the results of the search in relation to the search criteria. For example, the operator may search for a particular subscriber's set-top-box and then have the UI 140 draw the channel path such that the path expands from an icon of the set-top-box backwards to the relevant A-Server.

The search module 310 may be used to search for a channel, and then open the entire channel path. Typically the search module 310 is used to search by node, by channel, or by subscriber. The search result can be used by the exemplary monitoring engine 100 to build a channel path for display on the UI 140 in either direction, from subscriber to backend, or vice versa.

The illustrated monitoring engine 100 is just one example of component arrangement for purposes for description. Other arrangements with other components are possible in an exemplary monitoring engine 100.

Exemplary User Interface

In one implementation, the displayed representation of the IPTV network is a user-collapsible-expandable tree structure that follows the tiered organization of the IPTV network itself. The tree structure allows a human operator to rapidly locate and visualize any link, zero-in on a component, or tap-in point for monitoring AV quality, on the entire network without being overwhelmed with a visual representation that tries to display the entire network at once. Many configurations of the exemplary collapsible tree representation of the IPTV network are possible within the same implementation of the exemplary channel health-monitoring system. For example, as mentioned, the UI 140 can display a subscriber first and then expand to show links back to the backend A-Server.

A partial representation of this hierarchical tree structure 200 of the IPTV network is typically displayed in the UI 140 of the exemplary monitoring engine 100. The UI representation is typically either collapsed into a high level view of the IPTV network or else expanded so that the view is zoomed-in to only a segment of the IPTV network. The displayed representation is also typically limited to the delivery path of one channel at a time, although in some UI states components from several channel paths may be displayed. In most cases, the displayed representation of a selected part of the IPTV network consists of just a few nodes and links of the IPTV network at a time, with each node selectable for expanding or collapsing to a connected segment of the channel path being viewed. Because the tiers of the actual IPTV network are hierarchical in relation to each other, moving across tiers in the UI 140 has the effect of zooming-in and zooming-out in the view being displayed.

In order to display a collapsible representation of the hierarchical tree structure 200, the exemplary monitoring engine 100 first discovers the complete distribution path for each channel, or at least discovers the complete end-to-end path for the one channel currently in focus in the UI 140. The exemplary engine 100 typically does not display the entire path at once, which would be cumbersome, but allows the operator to drill down to problems by expanding the tree from a higher level node at which a problem is indicated to relevant sub-branches of the tree. The operator simply expands the tree at each indicated node in a given view. That is, as the operator travels down the tree from trunk level to leaf levels. If there is a problem, then at each view the node to expand (with the problem downstream from the node and as yet still collapsed from view) will be highlighted in some manner.

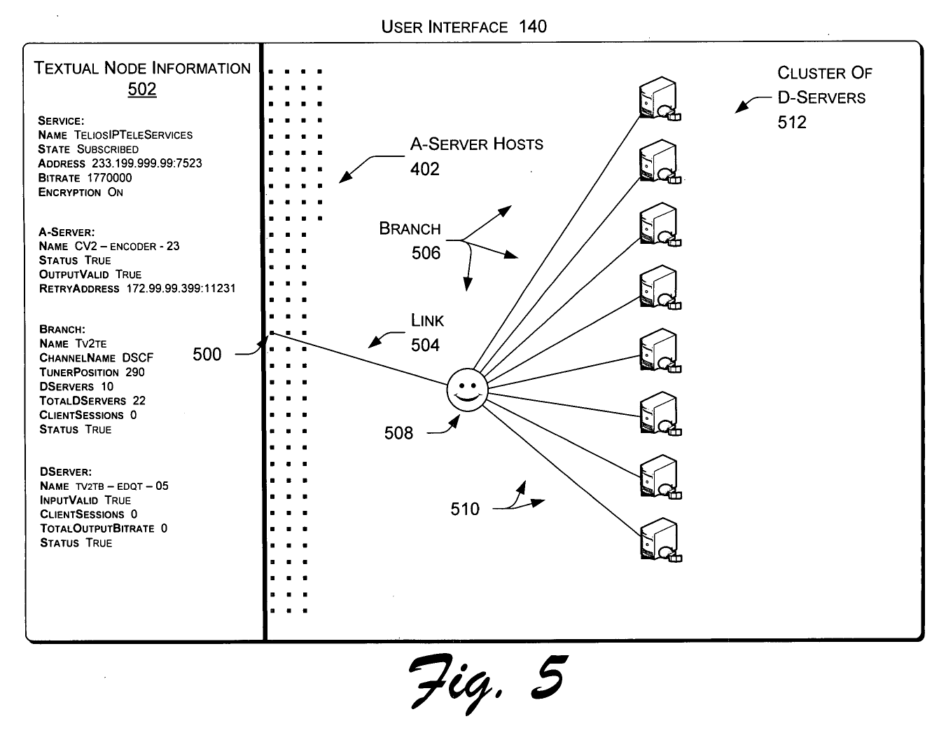

FIG. 5 shows the exemplary UI 140 as it displays a state of the hierarchical tree structure 200. Only a portion of the hierarchical tree structure 200 is expanded from the top-level view shown in FIG. 4. In the illustrated state, one A-Server 500 out of a collection of A-Server hosts 402 has been designated by an operator or selected by the exemplary monitoring engine 100. In one implementation, once a node or link has been selected for display or expansion, a textual readout of its status is posted in a node data 502 section of the UI 140, to be updated on the next ping of the proactive channel assessment module 306. In the illustrated example, a link 504 representing connection to one branch 506 of the channel distribution path associated with the selected A-Server 500 has been selected to visualize and/or show some condition of the IPTV network. The link 504 proceeds to a nodal point 508, which in turn expands to a cluster of links 510 and D-Servers 512.

In one implementation, a nodal point 508 in the displayed tree structure 200 can indicate a state of the links and nodes downstream from itself. A happy face (for example) in the node representation can indicate that there are no problems downstream in the cluster of links 510 and D-Server nodes 512 associated with the nodal point 508, while a red outline around the node (for example) can indicate the presence of a problem further downstream that should be visible when the node is visually expanded on the UI 140. A culprit component causing a problem may be indicated by a red circle with a cross through it (for example). In other words, if only the nodal point 508 is being displayed, then a happy face indicates that no problem would be revealed by clicking to further expand the nodal point 508 to show more downstream detail. If the health is not optimal, then the happy face (for example) may be replaced by a different icon or color depending on degree of health.

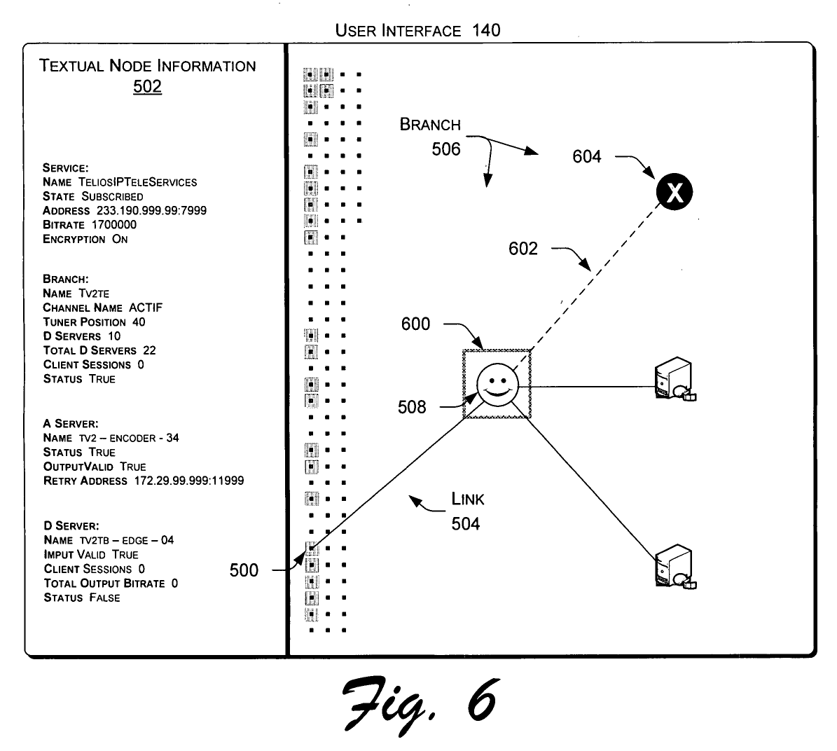

FIG. 6 shows the exemplary UI 140 in a state that displays a problem along the channel path. The A-Server 500 that hosts a channel that is down is highlighted, indicating that the A-Server 500 is working satisfactorily but that there is a problem downstream. The link 504 between the A-Server 500 and a branch 506 of the distribution path for the channel hosted by the A-Server 500 is represented as being functional. A healthy link may be indicated in the UI 140 by a color, such as green, or by a solid line, while an unhealthy link may be indicated by a different color, such as red, or by a dashed line. The nodal branch server 508 is indicated as being in a normal healthy state itself, but a problem indicator outline 600 indicates that there is a problem downstream. The icon for the nodal branch server 508 can be expanded to show the cluster of links (e.g., 602) and D-Servers (e.g., 604) downstream. The link 602 is indicated as having a problem and the D-Server 604 is indicated as being the problem component, explaining why the link 602 is non-functional. The textual node information 502 displays more detail about the healthy and unhealthy components.

Even when there is no problem, the UI 140 can be used to examine parts of the IPTV network to monitor the status of the components and links. For example, an operator might want to know the load on a cluster of D-Servers, or the level of AV quality at the input and output of a certain network stage.

Once the operator has collapsed or expanded the representation of the IPTV network to the desired degree, the operator can then highlight a displayed link or component to obtain status information, or can double-click, for example, to activate the AV visualization engine 308 anywhere on one or more links or components to see live rendering of the video at those points in the path. Because an IPTV uses IP multicast, the exemplary monitoring engine 100 can join the multicast of a channel (tune to it) and view a rendering of the stream whether there is a problem or not, anywhere in hierarchical tree structure 200 being displayed. Thus, the exemplary UI 140 makes it easy to compare the AV health between links.

Exemplary Method

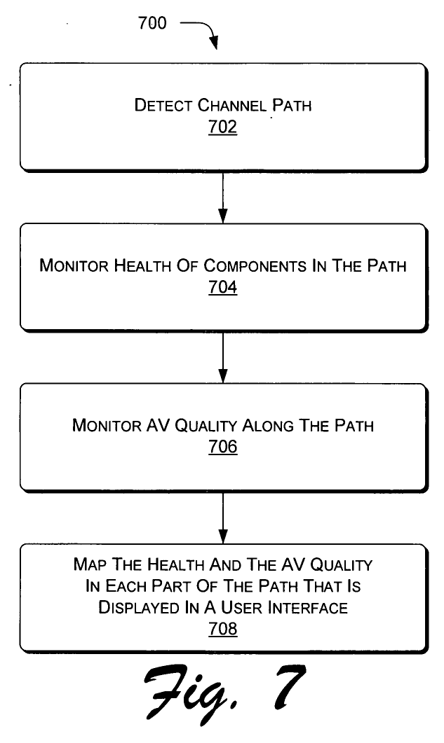

FIG. 7 shows an exemplary method 700 of real-time channel health-monitoring for Internet Protocol television. In the flow diagram, the operations are summarized in individual blocks. Parts of the exemplary method 700 may be performed by hardware, software, or combinations of both, for example, by components of the exemplary channel health-monitoring engine 100.

At block 702, the distribution path of a channel of IP television is detected. The detecting may be achieved, for example, by an end-to-end channel pathway engine 304. The detecting typically includes finding a succession of nodes, such as servers, that define links across the tiers of a multi-tier IP television network. Because the television network is based on IP, the topology of one or more channel paths in the network can be discovered from the backend source originating the channel (e.g., an A-Server) to the end subscriber (e.g., a set-top box), without disturbing or even communicating with the subscriber's equipment.

At block 704, the health of components along the path is monitored. The component health monitoring may be achieved, for example, by a pinging engine 320, that requests health information or receives health reports from each monitored component or endpoint in an entire network. The monitoring may be repeated at frequent intervals, and some parts of the monitoring may be continued in real-time. In one implementation, each ping retrieves the health parameters of every monitored component, without placing extra burden the components. In one implementation, the monitoring includes proactively tuning in to each channel to determine response times, latency, etc. Other health parameters may be monitored, such as uptime, downtime, availability, usage, load, load balance, number of errors, packet loss, etc.

At block 706, the AV quality along the path is monitored. The AV quality monitoring may be included with each pinging of component health as at block 704, above. The AV quality monitoring may also be performed in real-time, for example with an AV visualization engine 308 that joins the multicast of a channel and renders the video frames into actual images, from which the quality may be discerned. Whereas the component health monitoring typically examines health on an IP data packet level, the AV monitoring examines health on the level of video frames represented by the IP data packets.

At block 708, both the health and the AV quality are mapped to a representation of each part of the path that is displayed in a user interface. In one implementation, a part of the IP television network being examined is presented in a user interface as hierarchically connected to related parts of the IP television network. This can be accomplished by displaying a collapsible tree structure in which different view levels of a part of the network can be obtained by collapsing and expanding the tree. If a problem exists, then a higher level view designates which part of the tree to select to expand the tree for more downstream detail of the problem.

In one implementation, an operator can click on different parts of the tree, not only to expand and collapse the tree to trace the problem, but also to obtain health readout information of each selected component or link. In one implementation, double-clicking on more than one component or link initiates a side by side comparison of health data for the one or more selected items, or a side-by-side visual comparison of rendered video from the channel's IP data stream at the selected points.

Conclusion

The subject matter described above can be implemented in hardware, software, firmware, etc., or combination thereof. In certain implementations, the subject matter may be described in the general context of computer-executable instructions, such as program modules, being executed by a computing device or communications device. Generally, program modules include routines, programs, objects, components, data structures, etc. that perform particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

The foregoing discussion describes exemplary channel health-monitoring for IP television. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
detecting a path of a channel of Internet Protocol (IP) television;
monitoring health of components in the path;
monitoring audio-visual (AV) quality along the path; and
mapping both the health and the AV quality in each part of the path that is displayed in a user interface.

2. The method as recited in claim 1, wherein detecting a path includes determining the path from a source of the channel to an end of the path at a subscriber to the channel.

3. The method as recited in claim 1, further comprising:
detecting multiple paths of multiple channels of an IP television network;
monitoring health of components in the multiple paths;
monitoring AV quality along the multiple paths; and
mapping the health and the AV quality associated with each part of the multiple paths displayed in the user interface.

4. The method as recited in claim 3, wherein the detecting the multiple paths includes determining the multiple paths from a source end to destination end across a multi-tier architecture of the IP television network.

5. The method as recited in claim 1, wherein the monitoring health and monitoring AV quality further comprises measuring states of the components and the AV quality along the path at regular time intervals and updating the display of the health and the AV quality on the user interface.

6. The method as recited in claim 1, wherein the monitoring audio-visual (AV) quality along the path further comprises one of:
detecting AV jitter in each part of the path by measuring a video frame rate and an audio sample rate associated with each part of the path at regular time intervals; or
detecting a no-signal AV condition by measuring motion between a first and a last video frame of the path at regular time intervals.

7. The method as recited in claim 1, wherein the monitoring health includes pinging the components at regular intervals to obtain statuses, error reports, and AV quality measurements at each of the components of multiple channels of an IP television network in each ping.

8. The method as recited in claim 7, wherein the pinging imposes negligible burden on the performance of the components via using standard protocols of hyper text transfer protocol or transmission control protocol.

9. The method as recited in claim 7, wherein the pinging includes tuning to each channel and determining a response time.

10. The method as recited in claim 7, further comprising calculating statistics from the statuses, error reports, and AV quality measurements, wherein the statistics include one of channel availability, channel usage, channel uptime, channel response time, error counts, packet loss, frame discontinuity, and server load.

11. The method as recited in claim 7, wherein the pinging includes monitoring the AV quality by examining, for each channel, a data packet stream comprising video frames, wherein the examining is performed at multiple segments of the path of each channel.

12. The method as recited in claim 1, wherein the path of the channel is represented in the UI as a user-collapsible and user-expandable tree, and the relative health of each network component displayed in the tree is represented by one icon from a set of icons representing a range of component health and the relative AV quality of links between the network components is represented by one of a set of line types or line colors representing a range of AV qualities.

13. The method as recited in claim 12, further comprising marking a problem detected by the monitoring health and the monitoring AV quality on collapsed states of the tree in the user interface such that the marking indicates which part of the tree to expand to visualize greater downstream detail of the problem.

14. The method as recited in claim 12, wherein selecting multiple segments of the tree displays real-time AV quality at the multiple segments.

15. A system, comprising:
a channel path engine to determine a path of a channel of Internet Protocol (IP) television;
a pinging engine to gather first health parameters at regular time intervals from components along the path, wherein the first health parameters are associated with distribution of IP data packets by the components;
an audio-visual (AV) monitor associated with the pinging engine to gather second health parameters associated with video frames being represented by the IP data packets; and
a user interface to display a collapsible and expandable representation of the path, wherein the first health parameters and the second health parameters are indicated in the collapsible and expandable representation.

16. The system as recited in claim 15, wherein the user interface displays a problem indicated by the first or second health parameters such that the display of the problem indicates how to expand the representation to find a location of the problem.

17. The system as recited in claim 15, further comprising a search module to query the system to find one of a channel, a component, or a node of a subscriber of the IP television, wherein the user interface displays at least a part of the collapsible and expandable representation that is associated with the queried channel, component, or node.

18. The system as recited in claim 15, further comprising a statistics engine to obtain statistical information from the first health parameters and the second health parameters, including one of channel availability, channel usage, channel uptime, channel response time, error counts, packet loss, frame discontinuity, and server load.

19. The system as recited in claim 15, further comprising an alert engine to communicate information about the first or second health parameters to a human via one of email, telephone, fax or instant messaging.

20. A system, comprising:
means for determining paths of channels of an Internet Protocol (IP) television network;
means for displaying the paths as a collapsible tree;
means for determining health of components on the paths;
means for determining audio visual (AV) quality of video frames carried by IP data packets along different segments of the paths; and
means for displaying the health and the AV quality in the collapsible tree.
